(19) United States
(12) Patent Application Publication
(10) Pub. No.: US 2010/0109269 A1
(43) Pub. Date: May 6, 2010

(54) AXLE BRACKET FOR WHEELBARROW

(75) Inventors: BARRY R. ALBERT, Dillsburg, PA (US); Eric D. Hyp, Harrisburg, PA (US)

Correspondence Address: David C. Jenkins;Eckert Seamans Cherin & Mellott, LLC, 44th Floor, 600 Grant Street, Pittsburgh, PA, 15219, US

(73) Assignee: Ames True Temper, Inc., Camp Hill, PA (US)

(21) Appl. No.: 12/264,317

(22) Filed: Nov. 4, 2008

(51) Int. Cl. B62B 1/02; B60B 35/00

(52) U.S. Cl. 280/47.31; 301/125

(57) ABSTRACT

A wheelbarrow axle bracket that is also a handle end cap structured to enclose the forward end of each wheelbarrow handle member. As each end cap is disposed in the same general location that a traditional axle bracket would occupy, the end cap includes an axle support structured to be rotatably coupled to an axle.

### BACKGROUND OF THE INVENTION

1. Field of the Invention

This invention relates to axle brackets for a wheelbarrow and, more specifically, to an axle bracket for a light duty, or toy, wheelbarrow wherein the axle brackets are structured to act as end caps and are mirror images of each other.

1. Background Information

Wheelbarrows are one of mankind's oldest inventions. Generally, a tray or platform is supported on a frame having a forward wheel and two rearward supports. Two handles, which are typically coupled to, or unitary with, the frame extend from the rearward side of the tray. That is, a common frame comprises two elongated members extending from the front of the tray to a point beyond the rear of the tray whereby the frame members also form the handles. With this type of frame the elongated members are angled so as to be spaced apart behind the tray and adjacent to each other at the front of the tray. The wheel is typically disposed between the handles at the front end of the tray.

As wheelbarrows are generally structured to be tipped forward, and as wheelbarrows are generally structured to support heavy loads, it is very common for the forward tips of the handles to be protected, and linked together, by a wheelguard. The wheelguard is a bracket that extends laterally between the handle members and may act as a pivot point when the wheelbarrow is tipped forward. By covering the tips of the handles, the wheelguard hides the exposed grain of a wooden handle or the open end of a tubular, metal frame member. The wheelguard, by structurally linking the handles, also helps provide a robust frame assembly. As wheelbarrows are generally intended to carry heavy loads, a robust frame assembly is considered an advantage.

Because of this very few wheelbarrows are constructed without a wheelguard. One type of wheelbarrow that does not have a wheelguard is a toy wheelbarrow constructed of light materials and generally intended for use as an entertainment/learning device for children. Such toy wheelbarrows typically have the forward ends of the handles exposed and subject to degradation.

It is further noted that, because the handles are structured to be coupled to the wheel, the handles must extend at least to the location of the wheel. When a wheelguard is used, the handles typically extend beyond the wheel. Conversely, when no wheelguard is used there is no reason to have the handle extend beyond the wheel. Thus, on most toy wheelbarrows the handles end adjacent to the wheel. In other words, the wheel is typically coupled to the handles at the forward end of the handles.

The coupling for the wheel on a toy wheelbarrow could be as simple as a U-shaped bracket attached to the lower side of the handle and through which the axle is extended. Such brackets are typically held on by threaded fasteners. Thus, such axle brackets include several parts, require that holes be drilled, or made by the fasteners, in the handle front ends, and require time to assemble.

### SUMMARY OF THE INVENTION

The disclosed concept provides for a wheelbarrow axle bracket that is also a handle end cap structured to enclose the forward end of each handle member. As the end caps are disposed in the same general location that a traditional axle bracket would occupy, the end cap includes an axle support structured to be rotatably coupled to an axle. This configuration reduces manufacturing costs and assembly time as the traditional axle brackets are not included and do not have to be attached by a fastener to the handle front ends. Further, to reduce manufacturing costs, the end caps are structured to be “reversible.” That is, the end caps are symmetrical about a horizontal plane and may be used on the handle front end on either side of the wheelbarrow.

### BRIEF DESCRIPTION OF THE DRAWINGS

A full understanding of the invention can be gained from the following description of the preferred embodiments when read in conjunction with the accompanying drawings in which:

FIG. 1 is an isometric view of a wheelbarrow. FIG. 1A is a detail of the axle bracket.

FIG. 2 is an isometric view of an axle bracket.

FIG. 3 is a top view of an axle bracket.

FIG. 4 is a bottom view of an axle bracket.

FIG. 5 is a front view of an axle bracket.

FIG. 6 is a back view of an axle bracket.

FIG. 7 is a outer side view of an axle bracket.

FIG. 8 is an inner side view of an axle bracket.

FIG. 9 is an isometric view of an alternate axle bracket.

FIG. 10 is a front view of an alternate axle bracket.

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein, the word “unitary” means a component is created as a single piece or unit.

As used herein, unless otherwise noted, directional terms, such as, but not limited to, “forward,” “back,” “right,” “left,” “upper,” “lower,” and “lateral” correspond to the orientation of the wheelbarrow from the perspective of a user standing at the handle portion looking toward the tray—that is, the normal position a user would occupy to move the wheelbarrow. Such directional terms are not limiting upon the claims.

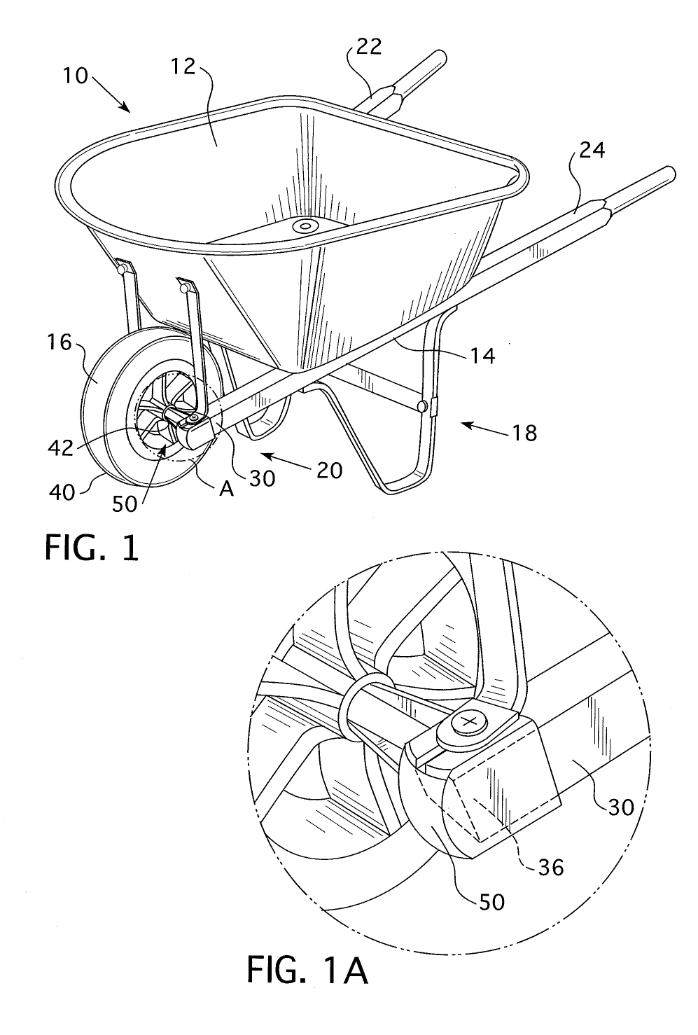

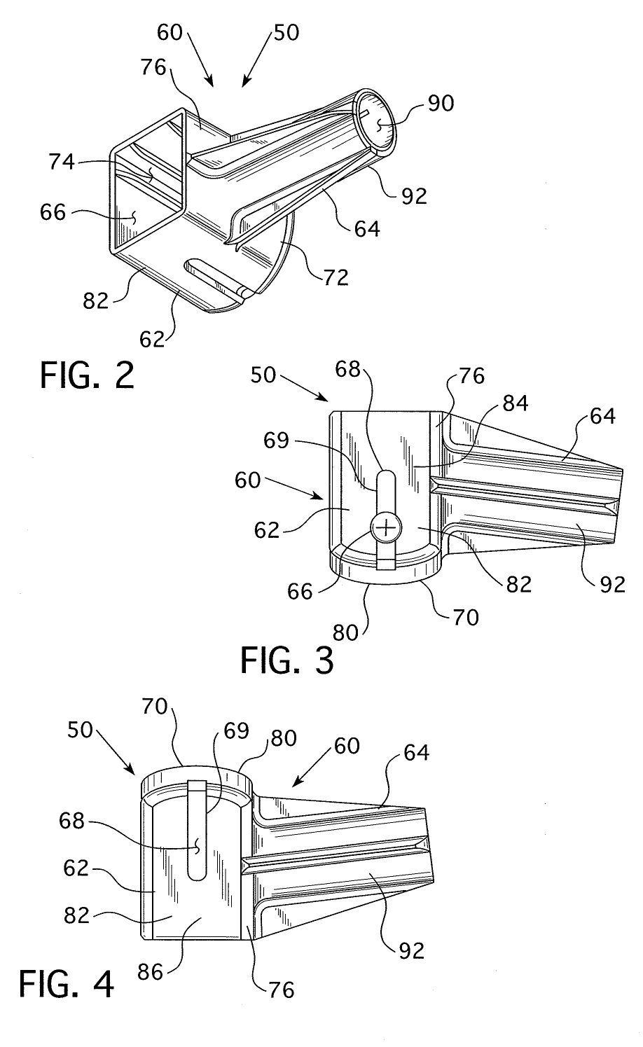

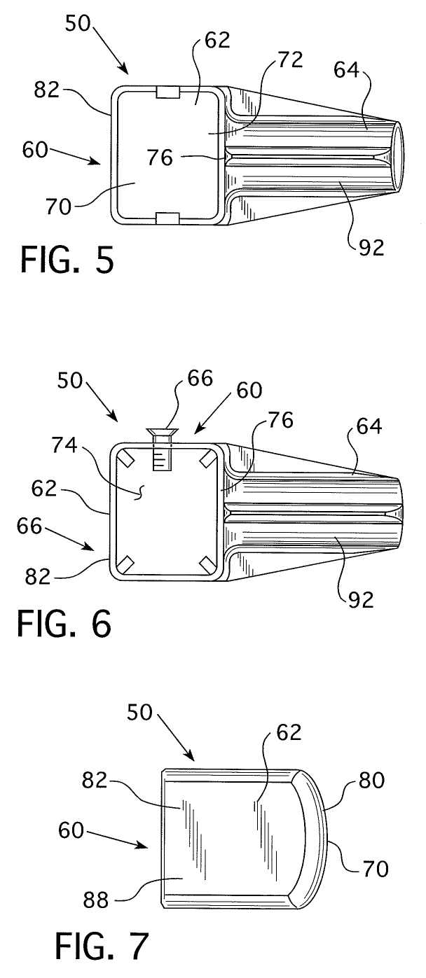

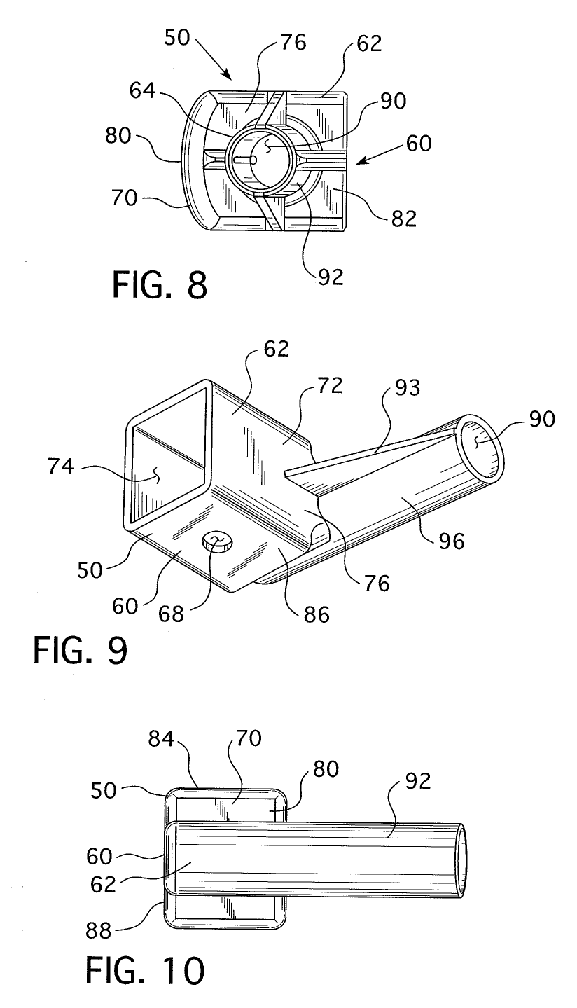

As shown in FIG. 1, a wheelbarrow 10 includes a tray 12, a frame assembly 14, and a wheel assembly 16. The tray 12 may be generally flat (not shown) or may be a hopper (as shown). The frame assembly 14 includes a plurality of members 18. The frame assembly members 18 form a wheel yoke 20 structured to be coupled to the wheel assembly 16. Preferably, the frame assembly members 18 include two elongated handle members 22, 24 that extend from near the front of the tray 12 to a point beyond the back of the tray 12. As is known, the handle members 22, 24 are positioned underneath the tray 12 and are angled relative to each other. That is, the portion of the handle members 22, 24 extending from the back of the tray 12 are spaced apart from each other and may be used as handles. The portion of the handle members 22, 24 near the front of the tray 12 are disposed relatively close to each other and form the wheel yoke 20. Alternately, the wheel yoke 20 may be constructed from frame members 18 that do not form the handles of the wheelbarrow 10 (not shown). In either embodiment, the wheel yoke frame members 26 each have a front end 30 with a front surface 36.

Typically, the frame members 18, including the wheel yoke frame members 26, are made from either wood (shown) or tubular metal members (not shown). With wooden wheel yoke frame members 26, the front surface 36 is exposed wood grain, with tubular metal members, the front surface 36 is an exposed opening. As such, the front surfaces 36 are unattractive and prone to damage, and an end cap assembly 60, as discussed below, is provided to cover each front surface 36.

The wheel assembly 16 includes a wheel 40 and an axle 42. The wheel assembly 16 is structured to provide a rotatable wheel 40. Typically, this is accomplished by having fixed axle 42 and having the wheel 40 rotatably disposed thereon. In such a configuration a bearing (not shown) is disposed between the wheel 40 and the axle 42. Alternately, the axle 42 may be fixed to the wheel 40 and the axle 42 may be rotatably coupled to a wheel yoke 20. That is, the wheel yoke 20 includes a bearing 21, or similar structure, into which a fixed axle 42 may be disposed. Either type of wheel assembly 16 may be used with the axle bracket 50 discussed below.

The wheel assembly 16 is coupled to the frame assembly 14 by a pair of opposed axle brackets 50 wherein an axle bracket 50 is disposed at each wheel yoke frame member front end 30. As noted above, it is desirable to protect the wheel yoke frame member front end 30. Accordingly, each axle bracket 50 includes an end cap assembly 60 having a body 62, an axle support 64 and coupling device 66. The end cap assembly body 62 includes at least a front side 70 structured to protect the wheel yoke frame member front surface 36. In the preferred embodiment, the end cap assembly body 62 also includes at least an inner side 72, that is, “inner” meaning the side of the end cap assembly body 62 adjacent the longitudinal centerline of the wheelbarrow 10. In a more preferred embodiment, the end cap assembly body 62 defines a substantially enclosed space 74. That is, the end cap assembly body 62 preferably includes a front wall 80 and a depending sidewall 82. The end cap assembly body 62 is open on the side opposite the front wall 80. Thus, the front surface of the front wall 80 is the front side 70 and a portion of the sidewall 82 is the inner side 72. In the embodiment shown in the figures, the wheel yoke frame members 26 have a generally square cross-section and the end cap assembly body 62 has a corresponding shape. That is, the end cap assembly body sidewall 82 has a plurality of generally planar sides including a top side 84, a bottom side 86, an outer side 88, and, as noted above, an inner side 72. It is noted that, when an end cap assembly 60 is installed on the opposing wheel yoke frame member 26, the top side 84 and bottom side 86 are reversed. However, the inner side 72 and outer side 88 remain, respectively, the inner side 72 and the outer side 88. The invention is not limited to a wheel yoke frame member 26 having a specific shape; the end cap assembly body 62 corresponds to the wheel yoke frame member's 26 shape. The end cap assembly enclosed space 74 is, preferably, slightly larger than the cross-section of the yoke frame member front end 30.

The end cap assembly axle support 64 is structured to be rotatably coupled to the wheel 40. As noted above, the wheel 40 may rotate on the axle 42 or the axle 42 may be fixed to the wheel 40 and rotate in the end cap assembly axle support 64. In either configuration, the wheel 40 is rotatable relative to the end cap assembly axle support 64. The end cap assembly axle support 64 is a construct defining a cylindrical cavity 90. Thus, the end cap assembly axle support 64 is preferably a tubular member 92 which may have additional support ribs 93 for strengthening the connection between the end cap assembly axle support 64 and the end cap assembly body 62. The end cap assembly axle support 64 and the end cap assembly body 62 are preferably a unitary body.

The end cap assembly axle support 64 is preferably positioned on an inner side 72 of the end cap assembly body 62. That is, the end cap assembly body inner side 72 has an exterior surface 76. Here “exterior” is used in reference to being outside the substantially enclosed space 74. Thus, the end cap assembly axle support 64 is disposed on the exterior surface 76 of the end cap assembly body inner side 72. Alternately, as shown in FIGS. 9 and 10, the end cap assembly axle support 64 may be disposed on the exterior surface of the end cap assembly body front wall 80. In this configuration, the end cap assembly axle support 64 may be open on both sides and, as such, the end cap assembly axle support 64 may define a passage (not shown) rather than a cavity 90. Accordingly, as used herein, the end cap assembly axle support “cavity 90” shall mean any defined space structured to support an axle 42, e.g., two spaced loops. In either embodiment, the longitudinal axis of the cavity 90 extends generally horizontally and generally perpendicularly to the longitudinal axis of the wheelbarrow 10, as described below.

To reduce manufacturing costs, it is advantageous for the end cap assemblies 60 to be generally identical. That is, preferably, an end cap assembly 60 may be used on either wheel yoke frame member 26. It is noted that because the wheel yoke frame members 26 are typically extensions of the handle members 22, 24, the wheel yoke frame member 26 are typically angled towards each other at the front ends 30. Because of this, and because the longitudinal axis of the cavity 90 extends generally perpendicularly to the longitudinal axis of the wheelbarrow 10, the end cap assembly axle support 64 may not extend generally perpendicular to the longitudinal axis of the end cap assembly body 62. That is, the longitudinal axis of the end cap assembly axle support 64 must extend at an angle relative to the axis of the end cap assembly body 62. The angle between the longitudinal axis of the end cap assembly axle support 64 and the axis of the end cap assembly body 62 depends upon the angle of the handle members 22, 24 relative to the longitudinal axis of the wheelbarrow 10. Further, because of this configuration, for the end cap assembly 60 to be “reversible,” i.e. usable on either side of the wheelbarrow 10, the end cap assembly body 62 and the end cap assembly axle support 64 must be generally symmetrical about a horizontal plane, wherein “horizontal” relates to the end cap assembly 60 only, not the end cap assembly 60 as it is positioned on the wheelbarrow 10.

The end cap assembly coupling device 66 is structured to couple the end cap 60 to the wheel yoke frame member front ends 30. Preferably, the end cap assembly coupling device 66 utilizes a friction fit, an adhesive, at least one fastener, or a combination thereof. For example, in one embodiment, the end cap assembly coupling device 66 includes ribs 100 on the inner surface of the end cap assembly body 62. In this configuration, when the end cap assembly body 62 is disposed over the yoke frame member front end 30, the ribs 100 create a friction fit. Alternately, an adhesive 102, such as, but not limited to, glue or epoxy, may be applied to a portion of the end cap assembly body 62 interior surface prior to positioning the end cap assembly body 62 over the yoke frame member front end 30. The cured adhesive 102 secures the end cap assembly 60 to the yoke frame member front end 30.

In the third alternative, the end cap assembly body 62 includes at least one fastener opening 68 and the end cap assembly coupling device 66 is a fastener 94, such as, but not limited to, a screw or bolt. The fastener 94 extend through the end cap assembly body opening 68 and into the yoke frame member front end 30 (shown) or the yoke frame member front surface 36 (not shown). The yoke frame member front end 30 may include a hole (not shown) structured to be engaged by the fastener 94. As shown, the end cap assembly body opening 68 may be an elongated slot 69. Such a slot 69 allows the user to adjust the position of the end cap assembly 60 longitudinally on the yoke frame member front end 30.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. An axle bracket for a wheelbarrow, said wheelbarrow having a tray, a wheel assembly and a frame assembly with a plurality of frame members, said frame members including at least two members that define a wheel yoke, said wheel yoke frame members each having a front end with a front surface, said wheel assembly having a wheel and an elongated axle, said axle bracket comprising:
an end cap assembly having a body, an axle support and coupling device;
said end cap body structured to cover said wheel yoke frame member front surface;
said axle support structured to be rotatably coupled to said wheel; and
said end cap coupling device structured to couple said end cap body to one said wheel yoke frame member front end whereby said wheel yoke frame member front surface is substantially covered.

2. The axle bracket of claim 1 wherein said end cap body is substantially symmetrical about a generally horizontal plane.

3. The axle bracket of claim 2 wherein
said end cap body has a front side and an inner side;
said inner side having exterior surface; and
said axle support extending from said inner side exterior surface.

4. The axle bracket of claim 3 wherein:
said end cap body has a front wall and depending sidewall, said body defining a substantially enclosed space;
said front side being said front side wall, said inner side being a portion of said sidewall; and
said enclosed space structured to enclose said wheel yoke frame member front end.

5. The axle bracket of claim 2 wherein said wheel yoke frame member front end has a generally square cross-section and wherein:
said end cap body sidewall has a plurality of generally planar sides including a top side, a bottom side, an outer side, and said inner side; and
said end cap enclosed space being slightly larger than said yoke frame member front end cross-section.

6. The axle bracket of claim 5 wherein said end cap assembly coupling device is selected from the group consisting of: a friction fit, an adhesive, or at least one fastener.

7. The axle bracket of claim 5 wherein:
said end cap assembly coupling device includes at least one fastener; and
said end cap body has at least one fastener opening therethrough.

8. The axle bracket of claim 2 wherein
said end cap body has a front side and an inner side;
said front side having outer surface; and
said axle support extending from said front side outer surface.

9. The axle bracket of claim 8 wherein:
said end cap body has a front wall and depending sidewall, said body defining a substantially enclosed space;
said front side being said front side wall, said inner side being a portion of said sidewall; and
said enclosed space structured to enclose said wheel yoke frame member front end.

10. The axle bracket of claim 9 wherein said end cap assembly coupling device is selected from the group consisting of: a friction fit, an adhesive, or at least one fastener.

11. A wheelbarrow comprising:
a tray;
a frame assembly with a plurality of frame members, said frame members including at least two members that define a wheel yoke;
said wheel yoke frame members each having a front end with a front surface;
a wheel assembly and having an elongated axle and a wheel;
a pair of said axle brackets, each axle bracket an having an end cap assembly with a body, an axle support and coupling device;
each said end cap body structured to cover one said wheel yoke frame member front surface;
said axle support structured to be rotatably coupled to said wheel; and
said end cap coupling device structured to couple said end cap body to one said wheel yoke frame member front end whereby said wheel yoke frame member front surface is substantially covered.

12. The wheelbarrow of claim 1 wherein:
each said end cap body is substantially symmetrical about a generally horizontal plane; and
said end caps are coupled to said frame assembly in a mirror image manner.

13. The wheelbarrow of claim 12 wherein
each said end cap body has a front side and an inner side;
each said inner side having outer surface; and
each said axle support extending from said inner side outer surface.

14. The wheelbarrow of claim 13 wherein:
each said end cap body has a front wall and depending sidewall, said body defining a substantially enclosed space;
each said front side being said front side wall, each said inner side being a portion of said sidewall; and
each said enclosed space structured to enclose one said wheel yoke frame member front end.

15. The wheelbarrow of claim 12 wherein:
said wheel yoke frame member front end has a generally square cross-section;
each said end cap body sidewall has a plurality of generally planar sides including a top side, a bottom side, an outer side, and said inner side; and
each said end cap enclosed space being slightly larger than said yoke frame member front end cross-section.

16. The wheelbarrow of claim 15 wherein each said end cap assembly coupling device is selected from the group consisting of: a friction fit, an adhesive, or at least one fastener.

17. The wheelbarrow of claim 15 wherein:
each said end cap assembly coupling device includes at least one fastener; and
each said end cap body has at least one fastener opening therethrough.

18. The wheelbarrow of claim 12 wherein
each said end cap body has a front side and an inner side;
each said front side having outer surface; and
each said axle support extending from said front side outer surface.

19. The wheelbarrow of claim 18 wherein:
each said end cap body has a front wall and depending sidewall, said body defining a substantially enclosed space;
each said front side being said front side wall, said inner side being a portion of said sidewall; and
each said enclosed space structured to enclose said wheel yoke frame member front end.

20. The wheelbarrow of claim 19 wherein said end cap assembly coupling device is selected from the group consisting of: a friction fit, an adhesive, or at least one fastener.
